(19) United States
(12) Patent Application Publication
(10) Pub. No.: US 2026/0076775 A1
(43) Pub. Date: Mar. 19, 2026

(54) METHODS AND SYSTEMS FOR INTRAORAL EVALUATION

(71) Applicant: Get-Grin Inc., Airmont, NY (US)

(72) Inventors: Yarden EILAT-BLOCH, Haifa (IL); Carmi RAZ, Gizo (IL)

(21) Appl. No.: 19/397,135

(22) Filed: Nov. 21, 2025

Related U.S. Application Data
(63) Continuation of application No. PCT/US2024/030836, filed on May 23, 2024.
(60) Provisional application No. 63/468,425, filed on May 23, 2023.
(60) Provisional application No. 63/641,021, filed on May 1, 2024.

(51) Int. Cl. A61C 7/00; A61C 9/00; A61C 13/34

(52) U.S. Cl. CPC A61C 7/002; A61C 9/0053; A61C 13/34

(57) ABSTRACT

Described herein are systems and methods for evaluating progress of a dental treatment plan of a subject, comprising: (a) providing a dental scan of the subject; (b) providing an intraoral model; (c) comparing the dental scan to the intraoral model, thereby obtaining an amount of deviation of an intraoral landmark in the dental scan from a target configuration of the intraoral landmark in the intraoral model; and (d) determining whether the user is on track with a stage of a dental treatment plan based on the amount of deviation.

### CROSS REFERENCE TO RELATED APPLICATIONS

This application is a continuation of International Application No. PCT/US2024/030836, filed May 23, 2024, which claims benefit of U.S. Provisional Application No. 63/468,425, filed May 23, 2023, and U.S. Provisional Application No. 63/641,021, filed May 1, 2024, each of which is incorporated herein by reference in its entirety.

### TECHNICAL FIELD

Described herein are methods and systems for intraoral assessment, and more specifically, methods and systems for generating data from oral representations.

### BACKGROUND

Dental professionals may treat and monitor a patient's dental condition based on in-person visits. Treatment and monitoring of a patient's dental condition may require obtaining dental images to provide a dentist information about a subject's intraoral condition, including the condition of the teeth, gums, or jaw. The quality of treatment and the accuracy of monitoring may vary depending on availability of such dental imaging. In some cases, suboptimal treatment outcomes may result if a patient is unable or unwilling to schedule regular visits that can provide dental imaging.

### SUMMARY

Recognized herein is a need for dental monitoring solutions to allow dental assessment, optionally remote dental assessment, without requiring a dental professional to be physically present with the patient. Some dental professionals may use conventional teledentistry solutions to accommodate patients' needs and schedules. However, such conventional teledentistry solutions may provide inadequate levels of supervision. Further, such conventional teledentistry solutions may be limited by an inaccurate or insufficient monitoring of a patient's dental condition based on one or more photos taken by the patient, if the photos do not adequately capture various intraoral features.

The present disclosure provides methods and systems for dental assessment, such as remote dental assessment. As used herein, the term “remote dental assessment” may refer to assessments conducted by remote personnel and may refer to the acquisition of one or more intraoral videos and/or intraoral images that can be assessed using a remote computing device, or can be sent to different remote locations for assessment. The methods and systems disclosed herein may provide a convenient solution to assess oral treatment progression and user experience for dental assessment presentation, in some embodiments, the methods and system disclosed herein may provide a solution to compare oral representation of a person from different times to get oral progression.

In an aspect, provided herein is a method for evaluating progress of a dental treatment plan of a subject, comprising: (a) providing a dental scan of the subject, wherein the dental scan comprises one or more intraoral videos or images of the subject, and wherein the one or more intraoral videos or images comprise an intraoral landmark of the subject; (b) providing an intraoral model, wherein the intraoral model comprises a target configuration of the intraoral landmark, wherein the target configuration of the intraoral landmark corresponds with a stage of the dental treatment plan; (c) comparing the dental scan to the intraoral model, thereby obtaining an amount of deviation of the intraoral landmark in the dental scan from the target configuration of the intraoral landmark in the intraoral model; and (d) determining whether the user is on track with the stage of the dental treatment plan based on the amount of deviation.

In some cases, the one or more intraoral videos or images are acquired using a mobile digital camera and a hollow tubular adapter, wherein a first opening of the hollow tubular adapter is configured to attach to the mobile digital camera, wherein a second opening of the hollow tubular adapter is configured to contact lips of the subject. In some cases, the comparing in (c) is performed in two dimensions (2D). In some cases, the comparing in (c) is performed in three dimensions (3D). In some cases, the intraoral model is a three-dimensional (3D) model.

In some cases, the intraoral model is of the same subject. In some cases, the intraoral model is of a different subject. In some cases, the comparing in (c) comprises comparing an appearance, a shape, or a position of the intraoral landmark. In some cases, the intraoral landmark comprises a hard tissue. In some cases, the intraoral landmark comprises a soft tissue. In some cases, the intraoral landmark comprises a tooth.

In some cases, the dental treatment plan comprises an orthodontic treatment plan of the subject. In some cases, the intraoral model comprises a 3D representation of an orthodontic aligner associated with the stage of the treatment plan. In some cases, the method further comprises displaying a visual representation of the amount of deviation over the intraoral landmark in the dental scan or the intraoral model. In some cases, the visual representation of the amount of deviation comprises a color of the intraoral landmark. In some cases, a first color of the intraoral landmark represents that the subject is on track with the stage of the dental treatment plan. In some cases, a second color of the intraoral landmark represents that the subject is partially on track with the stage of the dental treatment plan. In some cases, a third color of the intraoral landmark represents that the subject is not on track with the stage of the dental treatment plan.

In some cases, the method further comprises determining movement of the intraoral landmark in the dental scan compared to an initial position of the intraoral landmark. In some cases, the intraoral landmark comprises a tooth of the subject. In some cases, the method further comprises displaying the movement of the intraoral landmark in comparison to total movement of the intraoral landmark targeted by the dental treatment plan.

In another aspect, provided herein is a system for evaluating progress of a dental treatment plan of a subject, comprising: a processor; a storage element connected to the processor; a display element; encoded instructions stored in the storage element, wherein the encoded instructions when implemented by the processor, configure the system to: (a) display a dental scan of the subject on the graphical display, wherein the dental scan comprises one or more intraoral videos or images of the subject, and wherein the one or more intraoral videos or images comprise an intraoral landmark of the subject; (b) display an intraoral model on the graphical display, wherein the intraoral model comprises a target configuration of the intraoral landmark, wherein the target configuration of the intraoral landmark corresponds with a stage of the dental treatment plan; (c) compare the dental scan to the intraoral model, thereby obtaining an amount of deviation of the intraoral landmark in the dental scan from the target configuration of the intraoral landmark in the intraoral model; and (d) determine whether the user is on track with the stage of the dental treatment plan based on the amount of deviation.

In some cases, the one or more intraoral videos or images are acquired using a mobile digital camera and a hollow tubular adapter, wherein a first opening of the hollow tubular adapter is configured to attach to the mobile digital camera, wherein a second opening of the hollow tubular adapter is configured to contact lips of the subject.

In some cases, the comparing in (c) is performed in two dimensions (2D). In some cases, the comparing in (c) is performed in three dimensions (3D). In some cases, the intraoral model is a three-dimensional (3D) model. In some cases, the intraoral model is of the same subject. In some cases, the intraoral model is of a different subject. In some cases, the intraoral model is a simulated model of the subject.

In some cases, the comparing in (c) comprises comparing an appearance, a shape, or a position of the intraoral landmark. In some cases, the intraoral landmark comprises a hard tissue. In some cases, intraoral landmark comprises a soft tissue. In some cases, the intraoral landmark comprises a tooth. In some cases, the dental treatment plan comprises an orthodontic treatment plan of the subject. In some cases, the intraoral model comprises a 3D representation of an orthodontic aligner associated with the stage of the treatment plan.

In some cases, the method further comprises displaying a visual representation of the amount of deviation on the graphical display over the intraoral landmark in the dental scan or the intraoral model. In some cases, the visual representation of the amount of deviation comprises a color of the intraoral landmark. In some cases, a first color of the intraoral landmark represents that the subject is on track with the stage of the dental treatment plan. In some cases, a second color of the intraoral landmark represents that the subject is partially on track with the stage of the dental treatment plan. In some cases, a third color of the intraoral landmark represents that the subject is not on track with the stage of the dental treatment plan.

In some cases, the method further comprises determining movement of the intraoral landmark in the dental scan compared to an initial position of the intraoral landmark. In some cases, the intraoral landmark comprises a tooth of the subject. In some cases, the method further comprises displaying, on the graphical display, the movement of the intraoral landmark in comparison to total movement of the intraoral landmark targeted by the dental treatment plan.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system of the present invention involves performing or completing selected tasks or steps manually, automatically, or a combination thereof. Moreover, according to actual instrumentation and equipment of preferred embodiments of methods, apparatus and systems of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

In order to understand the invention and to see how it may be carried out in practice, embodiments will now be described, by way of non-limiting examples only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a flow-chart schematically illustrating methods of estimating/evaluation an intraoral condition of a subject, in accordance with the principles of some embodiments described herein.

FIG. 2 schematically illustrates one or more steps in a method of estimating/evaluation an intraoral condition of a subject, in accordance with the principles of some embodiments described herein.

FIG. 3 is example of an image from a system that, among other things, can be used to estimate/evaluate an intraoral condition of a user, in accordance with the principles of some embodiments described herein.

FIG. 4 schematically illustrates a computer system that is programmed or otherwise configured to implement at least some of the methods disclosed herein, in accordance with the principles of some embodiments described herein.

FIG. 5 is a flow-chart schematically illustrating methods of estimating/evaluation an intraoral condition of a subject based on other a dental model, in accordance with the principles of some embodiments described herein.

FIGS. 6A and 6B are examples of hollow tubular adapters, in accordance with the principles of some embodiments described herein.

FIG. 7 is an example of an interface from a system that, among other things, estimates an intraoral condition of a user, in accordance with the principles of some embodiments described herein.

FIG. 8 is an example of an interface from a system that, among other things, estimates an intraoral condition of a user, and includes a graphical representative of progress made in a dental treatment plan, in accordance with the principles of some embodiments described herein.

### DETAILED DESCRIPTION OF EMBODIMENTS

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The systems and methods described herein can provide practitioners with a more precise method of tracking treatment progress to provides insights and control over patient treatment progress. The systems and methods described herein can provide precision tracking of a dental treatment plan, including orthodontic treatment monitoring. The systems and methods described herein can be used to analyze actual patient progress in real time and compare it to the original treatment plan stages. The systems and methods described herein can be compatible with most major aligner brands and custom digital braces providers. The systems and methods described herein can be used to compare the 2D scans received directly from a patient over their treatment lifecycle with the expected 3D stages of a treatment plan on a tooth-by-tooth level, allowing for detection of proximity to treatment goals or identification of off-track teeth.

The term “real-time,” as used herein, generally refers to a simultaneous or substantially simultaneous occurrence of a first event or action with respect to an occurrence of a second event or action. A real-time action or event may be performed within a response time of less than one or more of the following: ten seconds, five seconds, one second, a tenth of a second, a hundredth of a second, a millisecond, or less relative to at least another event or action. A real-time action may be performed by one or more computer processors.

As used herein, when a numerical value is preceded by the term “about”, the term “about” is intended to indicate +/−10% of that value. Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Whenever the term “more than,” “at least,” or “more than or equal to” precedes the first numerical value in a series of two or more numerical values, for example, more than or at least one equals to 1, 2, 10 or even more and it can represent even hundred or more.

The terms “a,” “an,” and “the,” as used herein, generally refer to singular and plural references unless the context clearly dictates otherwise.

### Overview

According to an aspect, the present disclosure provides methods and systems for intraoral assessment. As used herein, “intraoral assessment” may refer to assessment of an appearance or condition of an intraoral region of a subject. The methods and system disclosed herein may provide a convenient presentation of an intraoral assessment such as teeth morphology that include all aspects acquired by a dental scan. The methods and systems disclosed herein may provide dentists and orthodontists or any health care personal with a detailed analysis of the patient's dental condition based on a video or on one or more images of at least one tooth, such as one or more teeth, one or more dental arches or both dental arches of a subject, gums or in other soft tissue in the oral cavity, in some embodiments captured remotely by a user, in some embodiments, the user is the subject. In some embodiments the user is a person other than the subject, present at the same location as the subject and assessment of the captured video or image(s) is performed at a remote location.

As used herein the term “dental scope” or “dental adaptor” refer to a device that can be attached to a camera or mobile phone comprising a camera and enables capturing at least one intraoral image or videos of a subject. The term “dental scope” or “dental adaptor” may refer to a hollow tubular adapter wherein one opening of the hollow tubular adapter is attached to the mobile digital camera and the second opening of the hollow tubular adapter was in contact with the user inner lips and the lips lay on the outer of the second opening of the hollow tubular adapter. An example and possible uses can be seen in U.S. patent application Ser. No. 17/336,997.

As used herein, the terms “dental scan” or “oral scan” refers to intraoral videos or intraoral images, or oral video, or oral images that are the results of using the “dental scope” or “dental adaptor” as attached to a digital camera such as mobile device while acquiring an intraoral video or intraoral image. An example for dental scan, and possible uses, can be seen in U.S. patent application Ser. No. 17/336,997. The intraoral videos or intraoral images or the dental scan provided to the method and systems of the present disclosure may be implemented using a software application that is configured to enable a dental patient to capture videos and/or images of intraoral regions. The software application may be used by a user or a subject (e.g., a dental patient) in conjunction with a mobile device to remotely monitor a intraoral condition of the subject. The intraoral condition may comprise a development, a growth, a movement, an appearance, a condition, a physical arrangement, a position, and/or an orientation of the subject's teeth or/and the subject's soft tissues in the oral cavity.

As used herein, “remote monitoring” may refer to monitoring the intraoral region of a subject and/or a condition of an intraoral region of a subject, wherein the monitoring is performed at one or more locations remote from the subject. For example, a dentist or a medical specialist may monitor the intraoral anatomy or intraoral condition at a first location that is different than a second location at which the subject is located. The first location and the second location may be separated by a distance spanning at least 1 meter, 1 kilometer, 10 kilometers, 100 kilometers, 1000 kilometers, or more.

The remote monitoring may be performed by assessing an intraoral condition of the subject using one or more dental scans captured from the subject when the subject is located remotely from the dentist or a dental office. In some cases, the remote monitoring may be performed in real-time such that a dentist is able to assess the dental condition when a subject uses a mobile device to acquire one or more videos or images of one or more intraoral regions in the patient's mouth. The remote monitoring may be performed using equipment, hardware, and/or software that is not physically located at a dental office.

The software application for dental assessment may be configured to run on a mobile device. The mobile device may comprise a smartphone, a tablet, a laptop, or any suitable device that may be used by a patient to capture one or more dental assessments. The software application may be installed on a mobile device of a user. The software application may be a patient-side software application. Alternatively, the software application for dental assessment may be configured to run on a fixed-location device, such as a desktop computer. Alternatively, the software application for dental assessment may be configured to run on a remote location device, such as a compute cloud server or service.

The methods and systems disclosed herein may provide a convenient solution to assess oral treatment progression and user experience for intraoral assessment presentation, in some embodiments, the methods and system disclosed herein may provide a solution to compare oral representation of a person from different times to get oral progression.

As used herein, the terms “intraoral model” or “oral representation”, refer to a digital or physical presentation of the oral cavity, including dental scan images or videos, including digital or physical 3d model of the oral cavity such as STL model or 3d printing, including medical or non-medical imaging that can acquire hard tissue theurge soft tissues, such as X-ray, magnetic resonance imaging (MRI), computed tomography (CT), transillumination, and fluorescent imaging.

### Methods for Estimating Intraoral Condition of a User

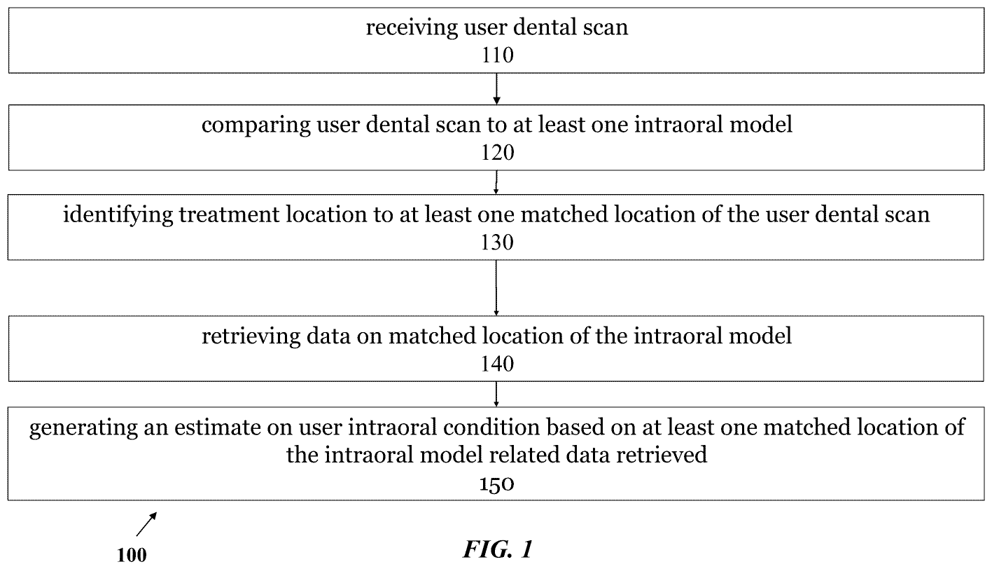

FIG. 1 schematically illustrates a method 100 to estimate user intraoral condition, in accordance with the principles of some embodiments described herein. The method includes
receiving user dental scan 100;
comparing user dental scan to at least one intraoral model 120;
identifying treatment location of at least one matched location of the user dental scan 130;
retrieving data on matched location of the intraoral model 140;
generating an estimate on user intraoral condition based on at least one matched location of the intraoral model related data retrieved 150.

According to some embodiments the dental scan 110 is a video or image of an intraoral region of a user and was acquired using a mobile digital camera and a hollow tubular adapter wherein one opening of the hollow tubular adapter is attached to the mobile digital camera and the second opening of the hollow tubular adapter was in contact with the user inner lips and the lips lay on the outer of the second opening of the hollow tubular adapter.

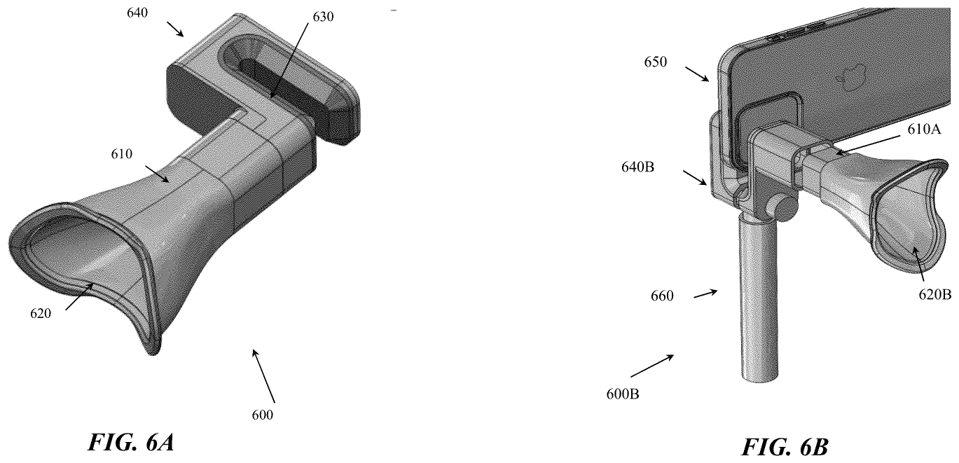

FIGS. 6A and 6B are exemplary hollow tubular adapters, in accordance with the principles described herein, the hollow tubular adapter 600 or 600B can be used with mobile camara 650 to capture dental scans of a user. As shown in FIGS. 6A and 6B, the hollow tubular adapter 610 and 610 A has one opening 630 directed toward digital camera 650 (if attached) and second opening 620 and 620B that can be inserted into user oral cavity in contact with the user inner lips and the lips lay on the outer of the second opening of the hollow tubular adapter, holder 660 can be used to hold the hollow tubular adapter while preforming the dental scan.

According to some embodiments, the intraoral model is an estimated three dimensional (3D) model prepared as a treatment forecast. In some cases, the intraoral model is an STL model predicting the movement of the teeth during an orthodontic treatment. In some embodiments, the estimated three dimensional (3D) model is computer assessment generated based on one or more previous dental scans of the user or generic dental scan. According to some embodiments, the intraoral model is a previous dental scan of the user.

According to some embodiments, the comparing 120 is done in two dimensions (2D). According to some embodiments, the intraoral model can be presented in the same perspective as the dental scan such that the dental scan and the intraoral model can be laid over each other.

According to some embodiments the intraoral model is of the same user. According to some embodiments, the intraoral model stored in a data set with other intraoral models of the same user.

According to some embodiments, the identifying 130 compares appearance, shape or position. According to some embodiments, the appearance can be color, shade, porosity, reflection or brightness. According to some embodiments, the shape can be change in the general shape of the object, height, tilt or boundaries. According to some embodiments, the position can be rotation, movement forward or back, change in height, tilt or side movement of an object.

According to some embodiments, the treatment location is a hard tissue, such as teeth or a tooth. In some embodiments the hard tissue can be braces or part of a braces.

According to some embodiments, the treatment location is a soft tissue, such as gams or part of the gums.

According to some embodiments the retrieving data 140 comprises at least one of appearance, shape, position, estimated time of the intraoral model, and/or the kind of intraoral model.

According to some embodiments, the generating an estimate 150 comprises analysis of the retrieved data 140 of the matched locations.

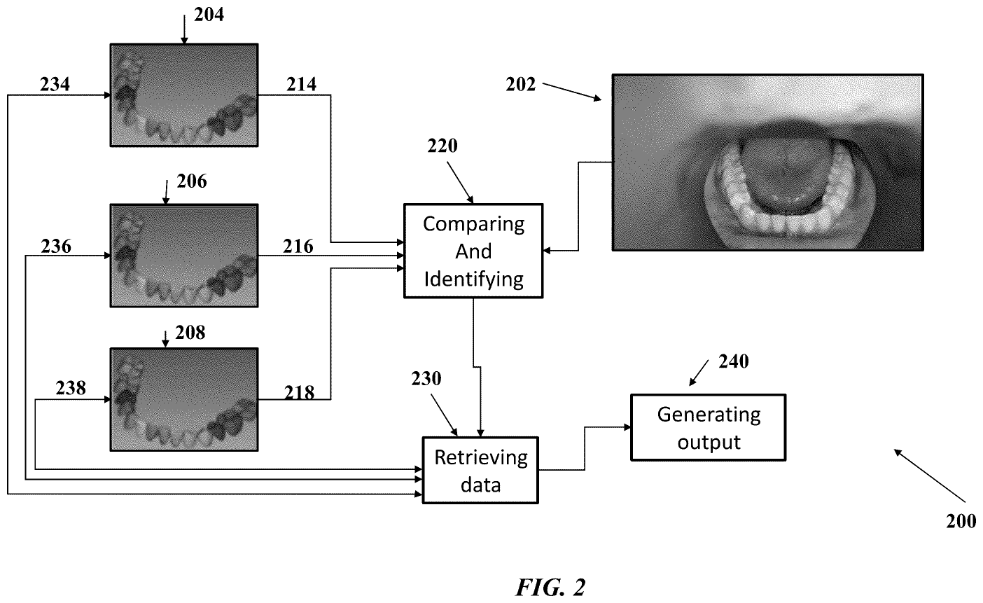

FIG. 2 schematically illustrates steps 200 in estimating user intraoral condition, in accordance with the principles described herein. The steps can include receiving user dental scan 202; comparing 214, 216, 218 user dental scan 202 to at least one intraoral model 204, 206, 208; identifying 220 treatment location to at least one matched location of the user dental scan 202; retrieving data 203 by 234, 236, 238 on matched location or locations of the intraoral model 204, 206, 208; and generating 240 an estimate on user intraoral condition based on at least one matched location of the intraoral model related data retrieved.

According to some embodiments, the dental scan 202 is compared to only one intraoral model. According to some embodiments, the dental scan is compared to different number of intraoral models, two, three, ten, twenty, or more.

In FIG. 2, the dental scan 202 is compared to three different intraoral models of the same user, each representing different pre prepared assessment of the teeth during orthodontic treatment. Intraoral model 204 can be a pre prepared assessment of the treatment condition of the user a few days before the time of the dental scan 202. The intraoral model 206 can be a pre prepared assessment of the treatment condition of the user at the time of the dental scan 202. Intraoral model 208 can be a pre prepared assessment of the treatment condition of the user few days after the time of the dental scan 202.

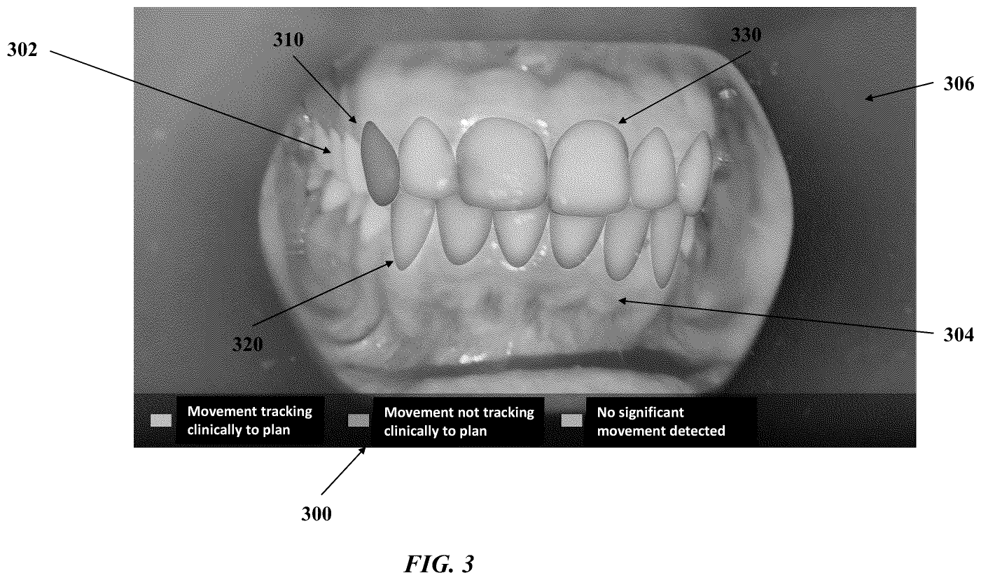

During the comparison 220, the treatment location or locations can be identified by matching or comparing similarity to one of the intraoral models 204, 206, 208, as shown in FIG. 3.

In some cases, at the next step 230, data of the matched treatment location or locations can be retrieved 234, 236, 238 from the intraoral models. The data retrieved can include at least one of appearance, shape, position, estimate time or stage of the intraoral model, and the type of intraoral models 204, 206, 208.

In some cases, at the next step 240, the retrieved data of the matched treatment location or locations is used to estimate the user's intraoral condition. For example, the retrieved data can assess the achievement of milestone orthodontic treatment or reassess the time required to achieve such milestone. In another example, the method can assess the treatment of soft tissue condition such as cancer or infection.

FIG. 3 shows an example image 300 that, among other things, can be used to estimate a user's intraoral condition, in accordance with the principles described herein.

The example image 300 shows the acquired intraoral scan of a user 302 when using a dental scope, the interior walls 306 of the dental scope frame, the intraoral of a user 302, and the gums 304. This example image 300 can be a result of some embodiments described above. In the example image 300, that tooth 310 (which can be shown in red) is not moving according to the planned treatment. In the example image 300, tooth 320 didn't move at all. In the example image 300, tooth 330 (which can be shown in green) moved according to the planned treatment.

### Systems for Estimating Intraoral Condition of a User

According to an aspect of some embodiments described herein, there is provided a computer implemented system to estimate user intraoral condition, comprising:
receiving user dental scan;
comparing user dental scan to at least one intraoral model;
identifying treatment location to at least one matched location of the user dental scan;
retrieving data on matched location of the intraoral model; and
generating an estimate on user intraoral condition based on at least one matched location of the intraoral model related data retrieved.

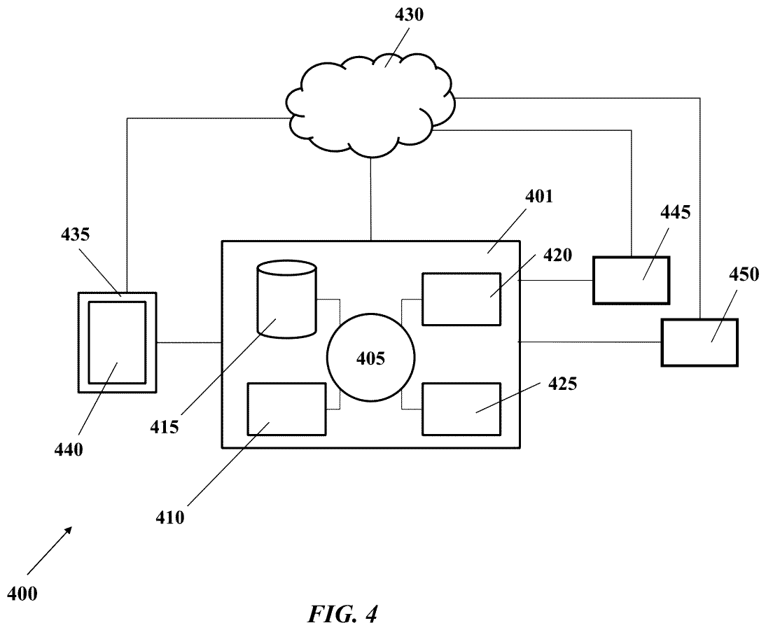

FIG. 4 shows a computer system 401 that is programmed or otherwise configured to implement a method to estimate user intraoral condition. The computer system 401 may be configured to, for example, process intraoral videos or images captured using the camera of a mobile device, and presenting dental scans, intraoral models or oral representations. The computer system 401 can be an electronic device of a user or a computer system that is remotely located with respect to the electronic device, or even in the cloud. The electronic device can be a mobile electronic device. The computer system 401 can be a smartphone.

The computer system 401 may include a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk, Solid State drive or equivalent storge unit), communication interface 420 (e.g., network adaptor) for communicating with one or more other systems, and peripheral devices 425, such as cache, other memory, data storage and/or electronic display adaptors. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are located external to the computer system 401 (e.g., on a remote server that is in communication with the computer system 401 through an intranet or the Internet).

The computer system 401 can communicate with one or more remote computer systems through the network 430. For instance, the computer system 401 can communicate with a remote computer system of a user (e.g., a subject, a dental patient, or a dentist). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 401 via the network 430.

Methods and systems as described herein can be implemented by way of machine (e.g., computer processor) executable code stored on an electronic storage location of the computer system 401, such as, for example, on the memory 410 or electronic storage unit 415. The machine executable or machine-readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such as memory (e.g., read-only memory, random-access memory, flash memory) or a storage unit. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, a portal for a subject or a user to view one or more intraoral images or videos captured using a mobile device of the subject or the user. In some cases, the electronic display 435 may be the feedback element providing the generated output, for example displaying message or shape or light in accordance to some embodiments. The portal may be provided through an application programming interface (API). A user or entity can also interact with various elements in the portal via the UI. Examples of UI's include, without limitation, a graphical user interface (GUI) and web-based user interface.

The computer system 401 can include or be in communication with a camera 445 for providing, for example, ability to capture videos or images of the intraoral of a user. Methods and systems of the present disclosure can be implemented by way of one or more algorithms. An algorithm can be implemented by way of software upon execution by the central processing unit 405. The algorithm can, for example, implement a method for presenting teeth morphology. The method may comprise processing videos or images captured using the camera of the mobile device or processing received user oral video or oral images and/or received user dental imaging image and executed to generate output.

The algorithm can, for example, implement a method of machine learning framework to generate data between two oral representations. In order to transfer a given capability into a machine, so-called supervised machine-learning techniques can be employed. Broadly speaking, a training dataset containing input images together with requested output (the “ground-truth”) is assembled. This dataset is assembled from input images which should resemble the expected input images to the machine after deployment as much as possible. The requested output can be any desired output type, e.g image classification, segmentation mask, image augmentation, text etc. The requested output can be gathered by manual human labeling, or by fusing data with other means of data gathering. This dataset is then fed into a machine-learning framework which uses an optimization process to control internal parameters in a model architecture (e.g SVM, neural network, random forest etc.). The optimization process goal is to reduce the error between the machine's output and the ground-truth output for each image in the training dataset. Once the optimization process has reached the required accuracy on the training dataset the machine's performance can be tested on a similar test dataset to validate the performance in real-world settings.

According to an aspect of described herein, there is provided a system 401 to estimate user intraoral condition, comprising: a processor 405; a storage element 415 connected to the processor 405; encoded instructions stored in the storage element 415, a digital display 435, and an ability to receive user input 440, wherein the encoded instructions when implemented by the processor 405, configure the system 401 to: receive user dental scan; compare user dental scan to at least one intraoral model; identify treatment location to at least one matched location of the user dental scan; retrieve data on matched location of the intraoral model, and generate an estimate on user intraoral condition based on at least one matched location of the intraoral model related data retrieved.

According to some embodiments, the dental scan is a video or image of an intraoral region of a user and was acquired using a mobile digital camera and a hollow tubular adapter wherein one opening of the hollow tubular adapter is attached to the mobile digital camera and the second opening of the hollow tubular adapter was in contact with the user inner lips and the lips lay on the outer of the second opening of the hollow tubular adapter.

FIGS. 6A and 6B are exemplary hollow tubular adapters, in accordance with the principles described herein. The hollow tubular adapter 600 or 600B can be used with mobile camara 650 to capture dental scans of a user. FIGS. 6A and 6B show the hollow tubular adapter 610 and 610 A, respectively. Both adapters can have one opening 630 directed toward digital camera 650 (if attached) and a second opening 620 and 620B that can be inserted into a user's oral cavity in contact with the user's inner lips. In some cases, the lips lay on the outer of the second opening of the hollow tubular adapter. Holder 660 can be used to hold the hollow tubular adapter while preforming the dental scan.

According to some embodiments, the intraoral model is an estimated three dimensional (3D) model prepared as a treatment forecast (for example, STL model predicting the movement of the teeth during an orthodontic treatment). According to some embodiments, the estimated three dimensional (3D) model is a computer assessment that is generated based on previous dental scans of the user or a generic dental scan. According to some embodiments, the intraoral model is a previous dental scan of the user.

According to some embodiments, the comparing is done in two dimensions (2D). According to some embodiments, the intraoral model can be presented in the same perspective as the dental scan in a way such that the dental scan and the intraoral model can be laid over each other.

According to some embodiments, the intraoral model is of the same user.

According to some embodiments, the identifying compares appearance, shape or position. According to some embodiments, the appearance can be color, shade, porosity, reflection or brightness. According to some embodiments, the shape can be change in the general shape of the object, height, tilt or boundaries. According to some embodiments, the position can be rotation, movement forward or back, change in height, tilt or side movement of an object.

According to some embodiments, the treatment location is a hard tissue, such as teeth or a tooth. In some embodiments, the hard tissue can be a braces or part of a braces.

According to some embodiments, the treatment location is a soft tissue, such as gums or part of the gums.

According to some embodiments, the retrieving data comprises at least one of appearance, shape, position, estimate time intraoral model, and kind of intraoral model.

According to some embodiments, generating an estimate comprises analysis of the retrieved data of the matched locations.

### Methods and Systems for Estimating Orthodontic Treatment of a User

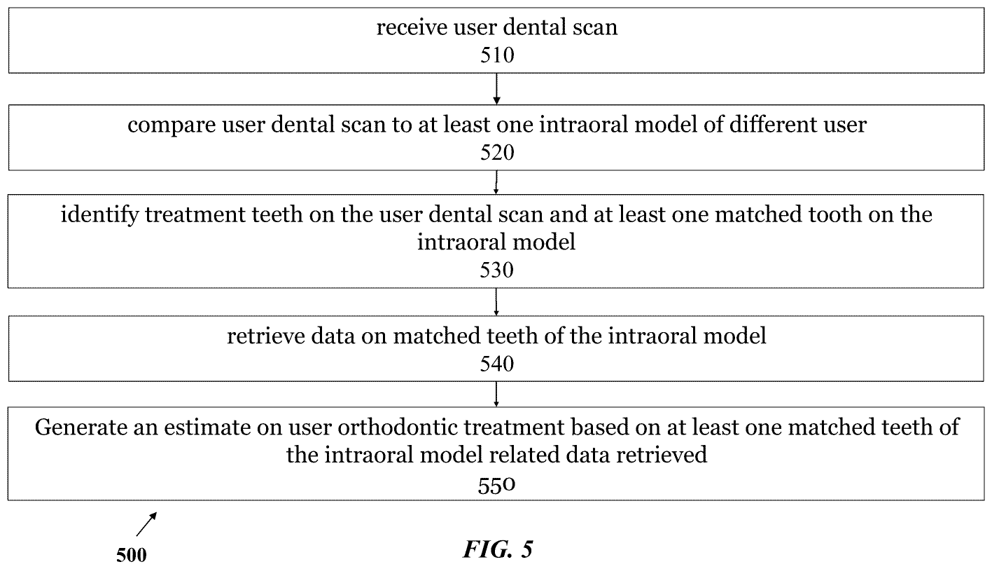

FIG. 5 schematically illustrates a method 500 to estimate user orthodontic treatment, in accordance with the principles of some embodiments of the present invention. The method includes receiving user dental scan 510;
comparing user dental scan to at least one intraoral model of different user 520;
identifying treatment teeth on the user dental scan and at least one matched tooth on the intraoral model 530;
retrieving data on matched location of the intraoral model 540;
generating an estimate on user orthodontic treatment based on at least one matched teeth of the intraoral model related data retrieved 550.

According to some embodiments, the dental scan 510 is a video or image of an intraoral region of a user and was acquired using a mobile digital camera and a hollow tubular adapter wherein one opening of the hollow tubular adapter is attached to the mobile digital camera and the second opening of the hollow tubular adapter was in contact with the user inner lips and the lips lay on the outer of the second opening of the hollow tubular adapter.

FIGS. 6A and 6B are exemplary hollow tubular adapters, in accordance with the principles described herein. The hollow tubular adapter 600 or 600B can be used with mobile camara 650 to capture dental scans of a user. FIGS. 6A and 6B show the hollow tubular adapter 610 and 610 A, respectively. Both adapters can have one opening 630 directed toward digital camera 650 (if attached) and a second opening 620 and 620B that can be inserted into a user's oral cavity in contact with the user's inner lips. In some cases, the lips lay on the outer of the second opening of the hollow tubular adapter. Holder 660 can be used to hold the hollow tubular adapter while preforming the dental scan.

According to some embodiments, the intraoral model is an estimated three dimensional (3D) model prepared as a treatment forecast (for example, STL model predicting the movement of the teeth during an orthodontic treatment). According to some embodiments, the estimated three dimensional (3D) model is a computer assessment generated based on previous dental scans of other users or generic dental scan.

According to some embodiments, the comparing 520 is done in two dimensions (2D). According to some embodiments, the intraoral model can be presented in the same perspective as the dental scan in a way that by laying the dental scan and the intraoral model over each other, according to some embodiments the comparing is done on a data base comprising more than one different intraoral models.

According to some embodiments, the intraoral model is a dental scan of a different user.

According to some embodiments, the intraoral model is a three dimensions (3D) model of a different user. According to some embodiments, the different user is a simulated or statistically created user.

According to some embodiments, the different user conducted an orthodontic treatment and has at least two intraoral models from different times.

According to some embodiments, the identifying 530 compares appearance, shape or position. According to some embodiments, the appearance can be color, shade, porosity, reflection or brightness. According to some embodiments, the shape can be the general shape of the object, height, tilt or boundaries. According to some embodiments, the position can be rotated, moved forward or back, changes in height, tilt or side movement of an object.

According to some embodiments, the retrieving data 540 comprises at least one of appearance, shape, position, estimated time of the intraoral model, and the type of intraoral model.

According to some embodiments, generating an estimate 550 comprises analysis of the retrieved data 540 of the matched teeth.

FIG. 2 schematically illustrates steps 200 in estimating user orthodontic treatment. The steps include receiving user dental scan 202;
comparing 214, 216, 218 to dental scan 202 to at least one different users intraoral model 204, 206, 208;
identifying 220 treatment tooth to at least one matched tooth of the user dental scan 202;
retrieving data 203 by 234, 236, 238 on matched tooth or teeth of the intraoral model 204, 206, 208; and
generating 240 an estimate on user orthodontic treatment based on at least one matched tooth of the different user intraoral model related data retrieved.

According to some embodiments, the dental scan 202 is compared to only one intraoral model, according to some embodiments the dental scan is compared to different number of intraoral models, two, three, ten, twenty or even more.

In the current example, the dental scan 202 is compared to three different intraoral models of different users.

During the comparison 220, the treatment tooth or teeth is identified by matching or similarity to one of the intraoral models 204, 206, 208.

In the current example, on the next step 230, data of the matched treatment tooth or teeth is retrieved 234, 236, 238 from the intraoral models. The data retrieved can include different user's data, such as gender, race age and the duration since the intraoral model was taken until the orthodontic treatment has finished.

In the current example on the next step 240, the retrieved data of the matched treatment tooth or teeth is used to estimate the progress of the user's orthodontic treatment. In some embodiments, the assessment comprises treatment method, treatment duration, treatment costs, treatment success rate, and other treatment aspects.

Going back to FIG. 4, according to an aspect described herein, there is provided a system 401 used to estimate user orthodontic treatment, comprising: a processor 405; a storage element 415 connected to the processor 405; encoded instructions stored in the storage element 415, a digital display 435, and an ability to receive user input 440, wherein the encoded instructions when implemented by the processor 405, configure the system 401 to:
receive a user dental scan;
compare the user dental scan to at least one intraoral model of different user;
identify treatment teeth on the user dental scan and at least one matched tooth on the intraoral model;
retrieve data on matched teeth of the intraoral model;
generate an estimate on user orthodontic treatment based on at least one matched teeth of the intraoral model related data retrieved.

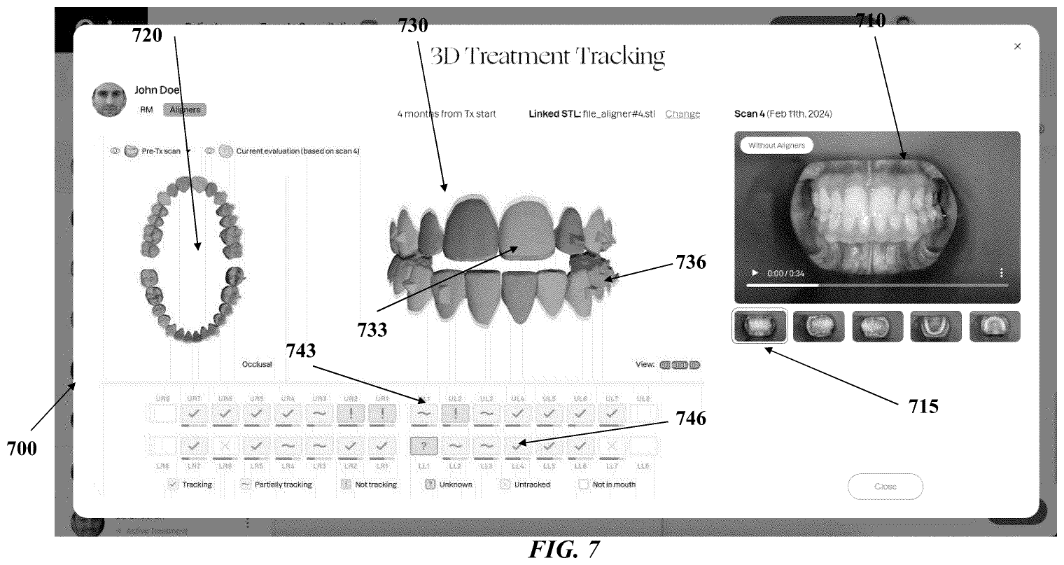

FIG. 7 is example image 700 from a system that, among others, estimate user intraoral condition. The specific dental scan 715 can be selected from one or more additional dental scans of the user. On the image, there is an area that presents the tracked teeth as an open arch 720. On the image, there is a 3D presentation 730 and a table that tracks the presentation of the current scan 743. 730 is presented such that the tooth that is partially tracking with the dental treatment plan 733 and tooth that is tracking with the dental plan 736 have difference appearances and marks on the corresponding chart 743. For example, the tooth that is partially tracking with the treatment plan 733 is indicated on the chart at 743 with a yellow color and wavy signal. The tooth that is tracking with the treatment plan 736 is shown on the chart at 746 with a green color and checkmark.

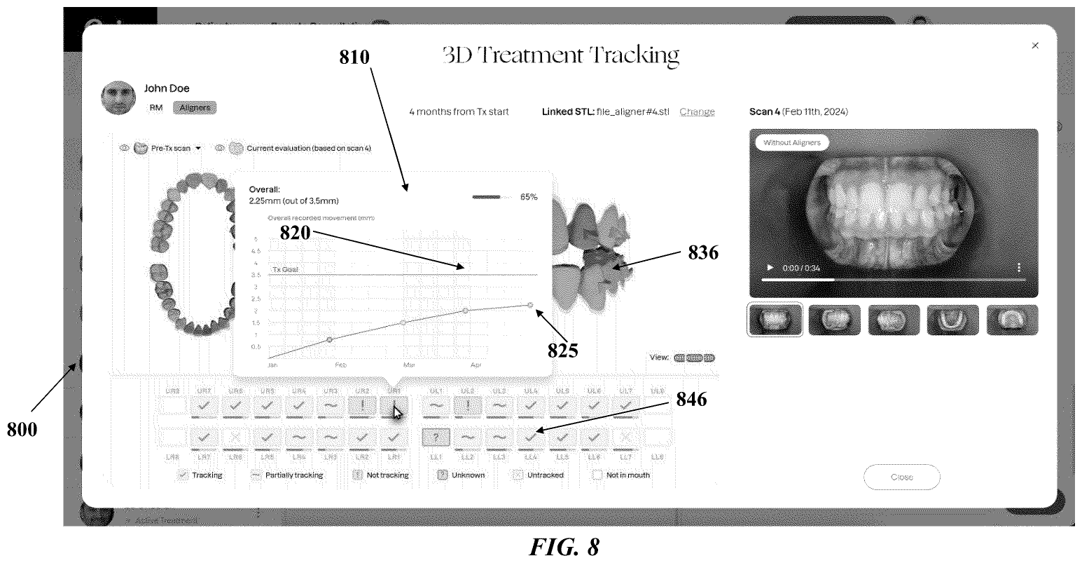

FIG. 8 is another example image 800 from a system that, among other, estimates user intraoral condition. An overall progression presentation 810 is shown for a single tooth 836 during the treatment. Tx goal 820 shows the final desired location of the tooth 436. According to some embodiments, the final desired location is retrieved from third party assumptions. Scan location 825 shows the tooth 836 that is tracking with the treatment plan. This tooth is also represented in the table at 846.

According to some embodiments, the dental scan is a video or images of an intraoral region of a user and was acquired using a mobile digital camera and a hollow tubular adapter wherein one opening of the hollow tubular adapter is attached to the mobile digital camera and the second opening of the hollow tubular adapter was in contact with the user inner lips and the lips lay on the outer of the second opening of the hollow tubular adapter.

FIGS. 6A and 6B are exemplary hollow tubular adapters, in accordance with the principles described herein. The hollow tubular adapter 600 or 600B can be used with mobile camara 650 to capture dental scans of a user. FIGS. 6A and 6B show the hollow tubular adapter 610 and 610 A, respectively. Both adapters can have one opening 630 directed toward digital camera 650 (if attached) and a second opening 620 and 620B that can be inserted into a user's oral cavity in contact with the user's inner lips. In some cases, the lips lay on the outer of the second opening of the hollow tubular adapter. Holder 660 can be used to hold the hollow tubular adapter while preforming the dental scan.

According to some embodiments the intraoral model is an estimated three dimensions (3D) model prepared as a treatment forecast for example STL model predicting the movement of the teeth during an orthodontic treatment. According to some embodiments, the estimated three dimension (3D) model is a computer assessment generated based on previous dental scans of other users or a generic dental scan.

According to some embodiments the comparing is done in two dimensions (2D). According to some embodiments the intraoral model can be presented in the same perspective as the dental scan such that the dental scan and the intraoral model can be laid over each other. According to some embodiments, the comparing is done on a database comprising more than one different intraoral models.

According to some embodiments, the intraoral model is a dental scan of a different user.

According to some embodiments, the intraoral model is a three dimension (3D) model of a different user. According to some embodiments, the different user is a simulated or statistically created user.

According to some embodiments, the different user conducted an orthodontic treatment and has at least two intraoral models from different times.

According to some embodiments, the identifying compares appearance, shape or position. According to some embodiments, the appearance can be color, shade, porosity, reflection or brightness. According to some embodiments, the shape can be change in the general shape of the object, height, tilt, or boundaries. According to some embodiments, the position can be rotation, movement forward or back, change in height, tilt or side movement of an object.

According to some embodiments, the retrieving data comprise at least one of appearance, shape, position, estimate time intraoral model, and kind of intraoral model.

According to some embodiments, the generating an estimate comprises analysis of the retrieved data of the matched teeth.

According to some embodiments, the retrieved data of the matched treatment tooth or teeth are used to generate an assessment of the user orthodontic treatment. According to same embodiments, the assessment comprises treatment method, treatment duration, treatment costs, treatment success rate, and other treatment aspects.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the mentioned specification, the descriptions and illustrations of the embodiments herein are not meant to be construed in a limiting sense.

Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for evaluating progress of a dental treatment plan of a subject, comprising:
(a) providing a dental scan of the subject, wherein the dental scan comprises one or more intraoral videos or images of the subject, and wherein the one or more intraoral videos or images comprise an intraoral landmark of the subject;
(b) providing an intraoral model, wherein the intraoral model comprises a target configuration of the intraoral landmark, wherein the target configuration of the intraoral landmark corresponds with a stage of the dental treatment plan;
(c) comparing the dental scan to the intraoral model, thereby obtaining an amount of deviation of the intraoral landmark in the dental scan from the target configuration of the intraoral landmark in the intraoral model; and
(d) determining whether the user is on track with the stage of the dental treatment plan based on the amount of deviation.

2. The method of claim 1, wherein the comparing in (c) is performed in two dimensions (2D).

3. The method of claim 1, wherein the intraoral model is a three-dimensional (3D) model.

4. The method of claim 1, wherein the intraoral model is of the same subject.

5. The method of claim 1, wherein the comparing in (c) comprises comparing an appearance, a shape, or a position of the intraoral landmark.

6. The method of claim 1, wherein the intraoral landmark comprises a hard tissue.

7. The method of claim 1, wherein the intraoral landmark comprises a soft tissue.

8. The method of claim 1, wherein the dental treatment plan comprises an orthodontic treatment plan of the subject.

9. The method of claim 8, wherein the intraoral model comprises a 3D representation of an orthodontic aligner associated with the stage of the orthodontic treatment plan.

10. The method of claim 1, further comprising displaying a visual representation of the amount of deviation over the intraoral landmark in the dental scan or the intraoral model.

11. A system for evaluating progress of a dental treatment plan of a subject, comprising: a processor; a storage element connected to the processor; a display element; encoded instructions stored in the storage element, wherein the encoded instructions when implemented by the processor, configure the system to:
(a) display a dental scan of the subject on the graphical display, wherein the dental scan comprises one or more intraoral videos or images of the subject, and wherein the one or more intraoral videos or images comprise an intraoral landmark of the subject;
(b) display an intraoral model on the graphical display, wherein the intraoral model comprises a target configuration of the intraoral landmark, wherein the target configuration of the intraoral landmark corresponds with a stage of the dental treatment plan;
(c) compare the dental scan to the intraoral model, thereby obtaining an amount of deviation of the intraoral landmark in the dental scan from the target configuration of the intraoral landmark in the intraoral model; and
(d) determine whether the user is on track with the stage of the dental treatment plan based on the amount of deviation.

12. The system of claim 11, wherein the one or more intraoral videos or images are acquired using a mobile digital camera and a hollow tubular adapter, wherein a first opening of the hollow tubular adapter is configured to attach to the mobile digital camera, wherein a second opening of the hollow tubular adapter is configured to contact lips of the subject.

13. The system of claim 11, wherein the comparing in (c) is performed in two dimensions (2D).

14. The system of claim 11, wherein the intraoral model is a simulated model of the subject.

15. The system of claim 11, wherein the comparing in (c) comprises comparing an appearance, a shape, or a position of the intraoral landmark.

16. The system of claim 11, wherein the intraoral landmark comprises a hard tissue.

17. The system of claim 11, wherein the dental treatment plan comprises an orthodontic treatment plan of the subject.

18. The system of claim 17, wherein the intraoral model comprises a 3D representation of an orthodontic aligner associated with the stage of the orthodontic treatment plan.

19. The system of claim 11, further comprising displaying a visual representation of the amount of deviation on the graphical display over the intraoral landmark in the dental scan or the intraoral model.

20. The system of claim 11, further comprising determining movement of the intraoral landmark in the dental scan compared to an initial position of the intraoral landmark.
